(19) United States
(12) Patent Application Publication
(10) Pub. No.: US 2005/0103780 A1
(43) Pub. Date: May 19, 2005

(54) Pedestal closure assembly

(76) Inventors: Jerome A. Maloney, Sugar Grove, IL (US); Albert McGovern, Naperville, IL (US)

Correspondence Address: HARNESS, DICKEY, & PIERCE, P.L.C, 7700 BONHOMME, STE 400, ST. LOUIS, MO, 63105, US

(21) Appl. No.: 10/712,612

(22) Filed: Nov. 13, 2003

(51) Int. Cl. H02G 9/00; E05B 65/48; B65D 6/28; B65D 8/18; B65D 55/14

(52) U.S. Cl. 220/4.02; 70/63; 220/210; 174/37; 174/38; 312/263; 312/223.6

(57) ABSTRACT

An improved outdoor telecommunication pedestal having a dome and a two part base. The base includes inner and outer horizontal and vertical ribs to greatly enhance in-ground stability. The dome also includes vertical ribs to engage slots in the base to give good security. Security is further enhanced by a spring loaded lock mechanism that requires only a quarter turn to unlock. A cam follower wall is provided on a slider of the lock to allow a snap attachment of the dome and the base once full engagement is reached.

### CROSS REFERENCE TO RELATED APPLICATIONS

Not applicable.

### STATEMENT REGARDING FEDERALLY SPONSORED RESEARCH

Not applicable.

### BACKGROUND OF THE INVENTION

1. Field of the Invention

The present invention relates to an improved pedestal closure assembly and more particularly, to a pedestal closure assembly that is easy and quick to install, easy to open and close and very stable in the ground into which the assembly is placed.

2. Description of the Related Art

Telecommunications, cable television, power distribution equipment and the like include primary cable loops, terminal blocks, wires and connectors. These elements are commonly located out of plant and subject to ambient weather conditions. Since the necessary equipment is located outside, a protective covering is required to safeguard the equipment from human interference as well as from the environment. Therefore, such protective covering must provide structural as well as environmental protection.

One such protective covering is in the form of a pedestal closure assembly. The pedestal structure includes a housing with a sufficient volume but occupying a small area and placeable in a convenient working orientation. Inside the housing cable pairs may be connected to each other and such connections are made at connector blocks which are mounted to a mounting plate inside the pedestal structure. The connector blocks include a number of terminals where the pairs of wires and the cable are stripped of their insulation and connected.

A base portion of the pedestal closure assembly is substantially buried in the ground but includes a passageway to permit underground cables to be received into the interior of the pedestal. The cables extend through the base section and are covered by a top or dome which is mounted on the base and attached to it. The pedestal closure assembly, when assembled and installed, should have sufficient structural strength to resist minor impacts as well as to resist environmental conditions such as wind, rain and blowing contaminants.

Examples of such pedestals may be found in U.S. Pat. Nos. 5,384,427; 5,412,960; 6,182,846; 6,198,041; 6,244,635 and 6,598,949, all of which are owned by the assignee of the present application. The disclosures of the above mentioned patents are included herein by reference.

### BRIEF SUMMARY OF THE INVENTION

Improvements in the above mentioned pedestals are always desirable. What is described here is a pedestal closure assembly comprising a substantially monolithic upper dome and a two-sectioned base for attaching to the dome. Each section of the base includes inner and outer ribs for stabilizing the pedestal in the ground.

There are a number of advantages, features and objects achieved with the present invention which are believed not to be available in earlier related devices. The pedestal disclosed here is easy and quick to install in the ground and once installed, has good stability. The pedestal does not pull out easily nor easily tilt away from a vertical position. The pedestal also is easy to open and close to facilitate service. There is only one lock mechanism to open (referred to as “one point of entry”) where a technician need only twist a lock one quarter turn or about 90 degrees with a lock opening tool to gain entry. Nevertheless, the pedestal disclosed here provides good closure security and is strong, relatively inexpensive and very reliable. A further advantage is that the lock/dome combination may be moved past wires and cables without snagging.

A more complete understanding of the present invention and other objects, advantages and features thereof will be gained from a consideration of the following description of preferred embodiments read in conjunction with the accompanying drawing provided herein. The preferred embodiments disclosed represent examples of the invention which are described here in compliance with Title 35 U.S.C. section 112 (first paragraph), but the invention itself is defined by the attached claims.

### BRIEF DESCRIPTION OF THE SEVERAL VIEWS OF THE DRAWING

FIG. 1 is an isometric view of a pedestal closure assembly embodiment disclosed herein having a dome and a short base.

FIG. 2 is an exploded isometric view of the pedestal closure assembly having a spade base and also illustrating an internally attached mounting plate.

FIG. 3 is a front elevation view of the pedestal closure assembly shown in FIG. 2.

FIG. 4 is a side elevation view of the pedestal closure assembly shown in FIGS. 2 and 3.

FIG. 5 is a rear elevation view of the pedestal closure assembly shown in FIGS. 2-4.

FIG. 6 is a top plan view of the base portion of the pedestal closure assembly shown in FIGS. 2-5 and of the attached mounting plate.

FIG. 7 is an enlarged front isometric view of the dome part of the pedestal closure assembly shown in FIGS. 1-5.

FIG. 8 is a rear isometric view of the dome shown in FIG. 7.

FIG. 9 is a rear upside down isometric view of the dome shown in FIGS. 7 and 8.

FIG. 10 is a bottom plan view of the dome shown in FIGS. 7-9.

FIG. 11 is a sectional elevation view of the dome taken along line 11-11 of FIG. 10.

FIG. 12 is an enlarged view taken within the circle 12-12 of FIG. 10.

FIG. 13 is a front isometric view of a front section of the base of the pedestal closure assembly.

FIG. 14 is a rear isometric view of the front section of the base shown in FIG. 13.

FIG. 15 is an upside down rear isometric view of the front section of the base shown in FIGS. 13 and 14.

FIG. 16 is a rear elevation view of the front section of the base shown in FIGS. 13-15.

FIG. 17 is a sectional view taken along line 17-17 of FIG. 16.

FIG. 18 is a top plan view of the front section of the base shown in FIGS. 13-15.

FIG. 19 is a section view taken along line 19-19 of FIG. 16.

FIG. 20 is a front isometric view of the rear section of the base.

FIG. 21 is a rear isometric view of the rear section of the base shown in FIG. 20.

FIG. 22 is an upside down rear isometric view of the rear section of the base shown in FIGS. 20 and 21.

FIG. 23 is a front elevation view of the rear section of the base shown in FIGS. 20-22.

FIG. 24 is a bottom plan view of the rear section of the base shown in FIGS. 20-23.

FIG. 25 is a sectional plan view taken along line 25-25 of FIG. 23.

FIG. 26 is a sectional plan view taken along line 26-26 of FIG. 23.

FIG. 27 is a sectional elevation view taken along line 27-27 of FIG. 23.

FIG. 28 is a side elevation view of the short version of the rear section of the base.

FIG. 29 is an enlarged front isometric view of a slide lock.

FIG. 30 is a rear isometric view of the slide lock assembly shown in FIG. 29.

FIG. 31 is a front elevation view of the slide lock assembly shown in FIGS. 29 and 30.

FIG. 32 is a sectional plan view taken along line 32-32 of FIG. 31.

FIG. 33 is a sectional elevation view taken along line 33-33 of FIG. 31.

### DETAILED DESCRIPTION OF PREFERRED EMBODIMENTS OF THE INVENTION

While the present invention is open to various modifications and alternative constructions, the preferred embodiments shown in the various figures of the drawing will be described herein in detail. It is understood, however, that there is no intention to limit the invention to the particular embodiments, forms or examples which are disclosed here. On the contrary, the intention is to cover all modifications, equivalent structures and methods, and alternative constructions falling within the spirit and scope of the invention as expressed in the appended claims, pursuant to Title 35 U.S.C. section 112 (second paragraph).

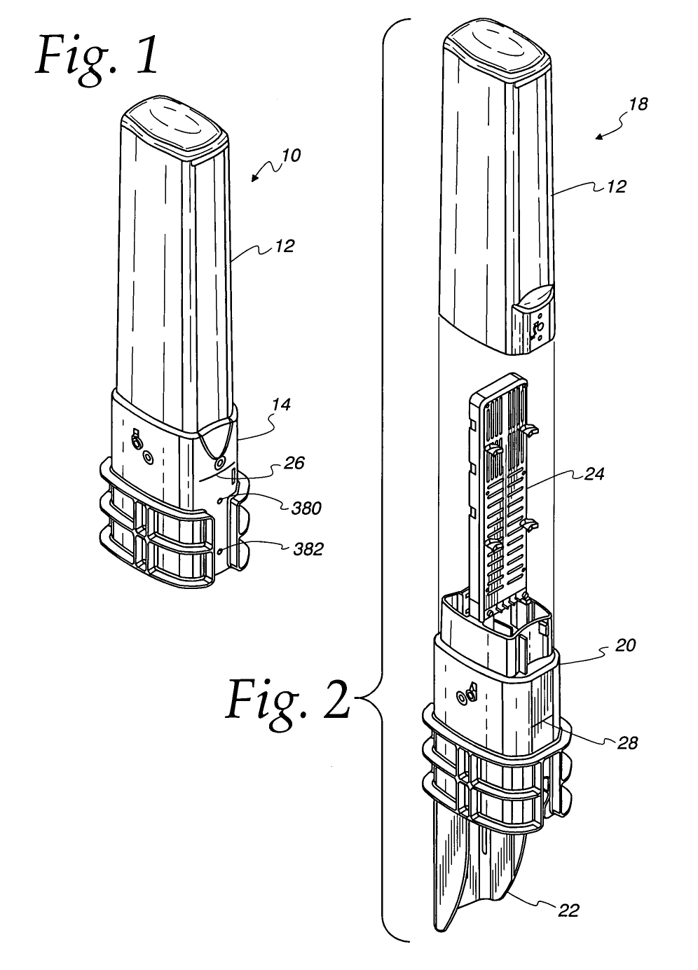

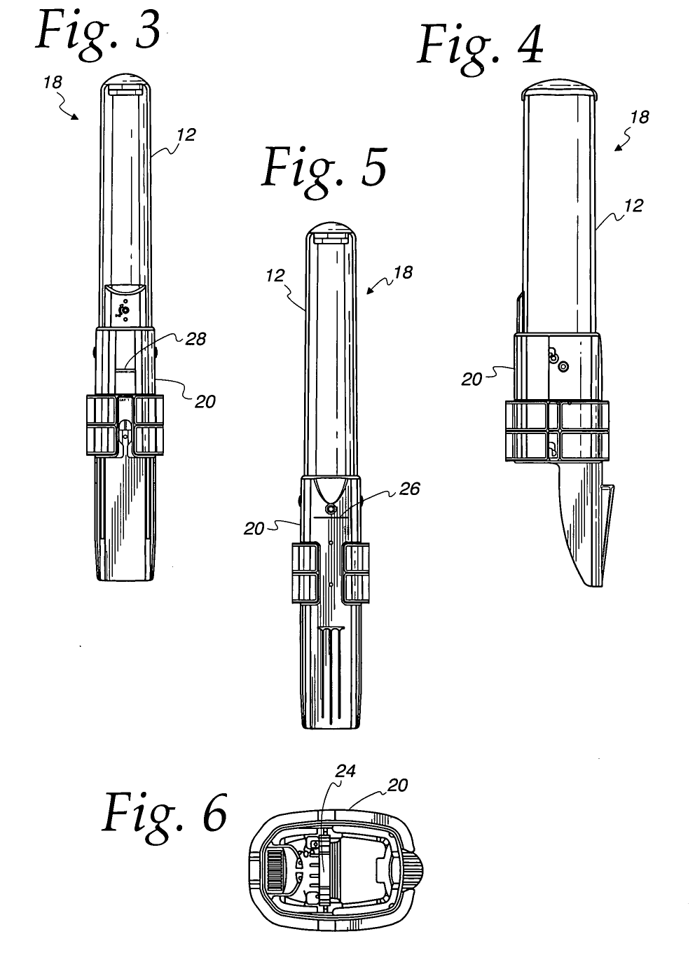

Referring now to FIG. 1, there is illustrated a pedestal closure assembly 10 showing an embodiment with a cover or dome part 12 and a base part 14. In the FIG. 1 embodiment, the base is a short version. In FIGS. 2-5, a second embodiment of the base part 18 is illustrated where the dome 12 is identical to the dome shown in FIG. 1 but the base part 20 has an extension or spade 22 integrally molded with the remainder of the base and extending downwardly.

Attached to the base for mounting in the interior of the pedestal assembly is a mounting plate 24. The mounting plate allows wires from an underground cable to be attached to connectors which are supported by the mounting plate. Underground cables are received by the pedestal closure assembly from below the pedestal. In normal usage, the pedestal is anchored in the ground to approximately the level shown by front and rear “ground lines” 26, 28.

More detail of similar pedestals and their operation may be acquired by reference to the four above mentioned patents.

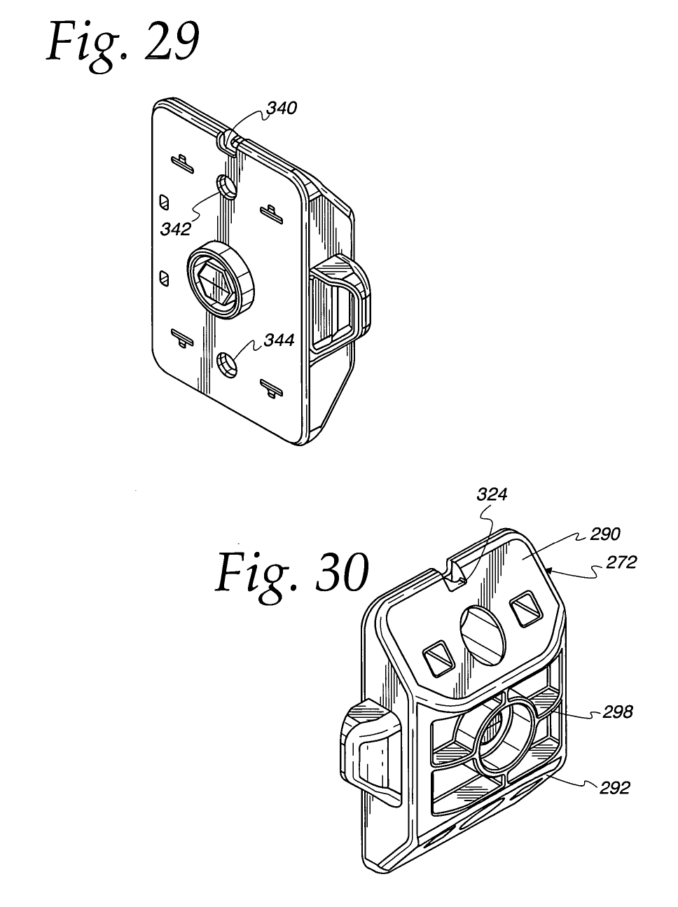

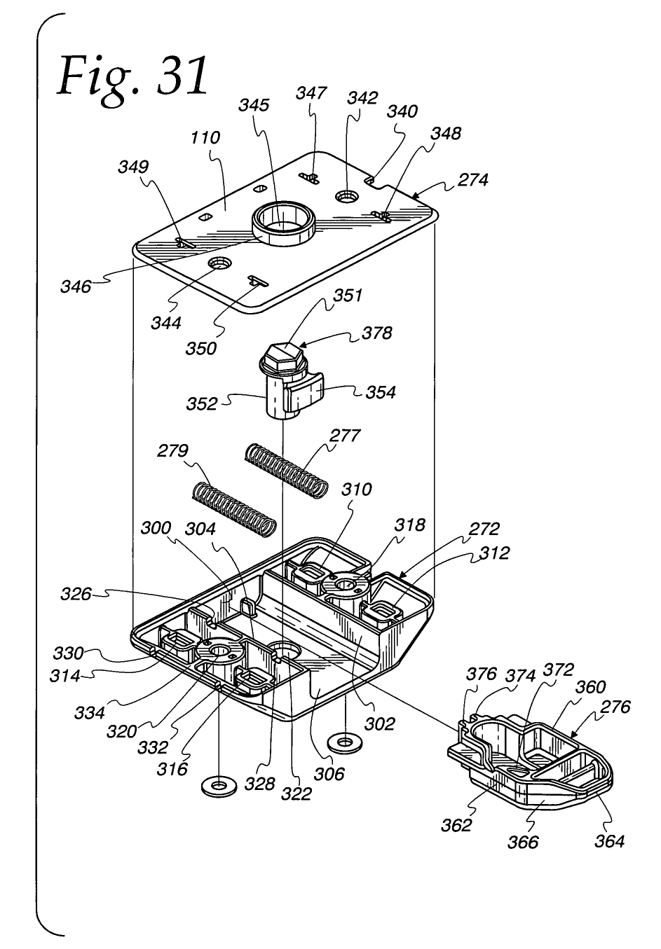

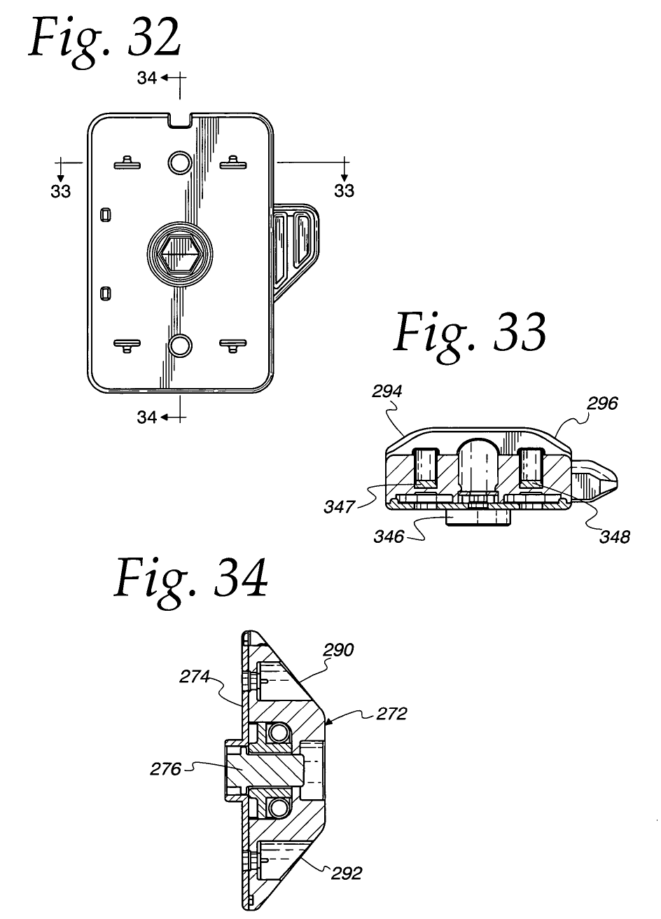

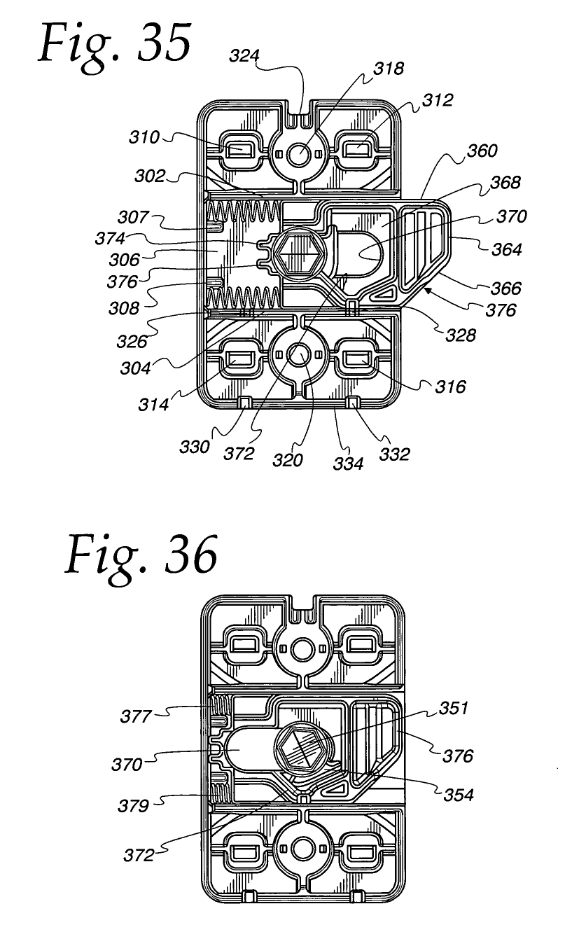

Referring now to FIGS. 1-9, the dome 12 includes a front wall 30, left and right side walls 32, 34, a rear wall 36 and a top wall 38. The dome includes interior surfaces, such as the surface 40, FIG. 9, and an internal chamber 42 formed by the front, rear, side and top walls. At the lower end portion 43 of the front wall is a bulge 44 to accommodate a lock mechanism as will be described below in relation to FIGS. 29-36. The bottom 46 of the dome is open and it is intended that the dome be received in a telescoping fashion by the base.

At the bulge 44 three openings 50, 52, 54 are formed in vertical alignment, two small openings 50, 54 for rivets to attach the lock to the dome, and a central opening 52 for insertion of a lock tool to rotate the lock mechanism through 90 degrees to “unlock” the dome from the base and allow removal of the dome for service of the equipment within the pedestal or for replacement of the dome should it be damaged.

It is to be noted that above the three openings, the dome is a single molded piece. This is important to operation in the field. It is desirable that the dome perform as a “bell jar” in flood situations. By bell jar, it is meant that water rising from beneath the dome will cause an increasing air pressure in the upper portion of the dome above the water level. This has the effect of suppressing the rising water to keep the water away from the electrical wires and connectors inside the pedestal.

The dome is formed of a suitable synthetic resin, such as high density polyethylene, and has a normal wall thickness of 0.180 inches generally and about 0.200 inches at the bulge.

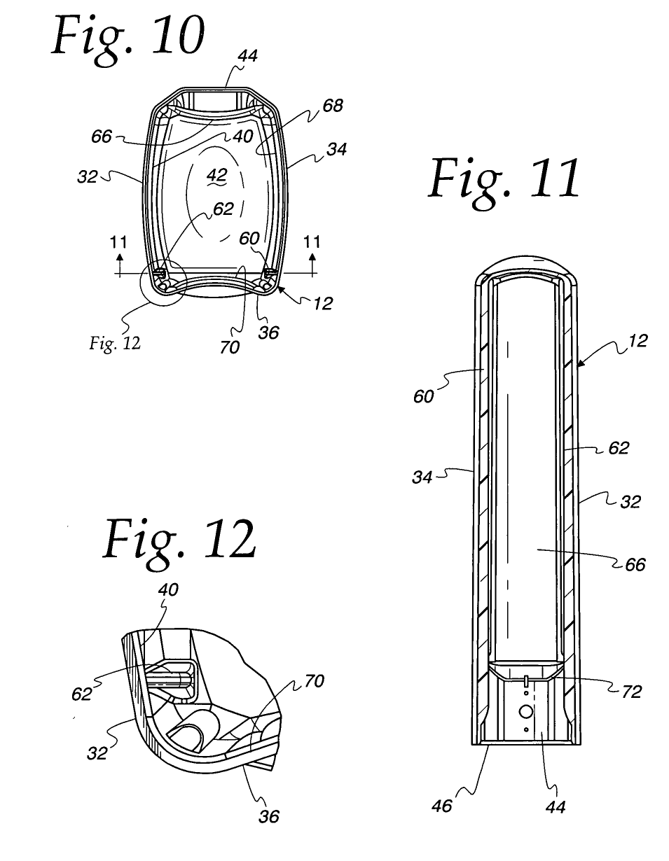

Referring now to FIGS. 10-12, the dome has two oppositely disposed vertically extending ribs 60, 62 projecting outwardly from the inner surfaces of the dome into the chamber formed by the dome. The vertical ribs start about one inch from the bottom 46 of the dome. As will be explained, these ribs engage with corresponding slots formed in the base thereby securing the rear of the dome to the base while the lock secures the front of the dome to the base.

The dome includes a front interior surface 66, a left side interior surface 40, a right side interior surface 68 and a rear interior surface 70. The lock bulge 44 is formed in the front wall and the lock will attach to the front interior surface 66. The lock mechanism has a thickness generally matching the extent of the bulge so that the lock mechanism does not extend in any substantial way into the internal chamber formed by the dome. This facilitates moving the dome past the mounting plate 24 when wires and connectors are attached to the mounting plate and not causing a “catch” or snag. The lock ribs 60, 62 are formed along the left and right side interior surfaces 40, 68 near the rear interior surface 70. The ribs provide for an engagement between the dome and the base at the rear of the assembly to complement an abutment between the lock mechanism and the base at the front of the assembly. This ensures good security. The vertical ribs and slots also provide an alignment feature when placing the dome over the base and the ribs act to strengthen the dome and make it more robust.

Integrally formed with the dome is a small tab 72 which is used to key the location of the lock mechanism and facilitate assembly of the lock mechanism and the dome.

It is now apparent that above the three aligned openings 50, 52, 54 for mounting the lock mechanism, there are no further openings in the dome at an elevation above the three openings, thereby allowing the “bell jar” effect to be accomplished. Also, as is now apparent, the dome is strong and relatively inexpensive since the dome is molded as one piece, and the dome and lock mechanism will provide good security.

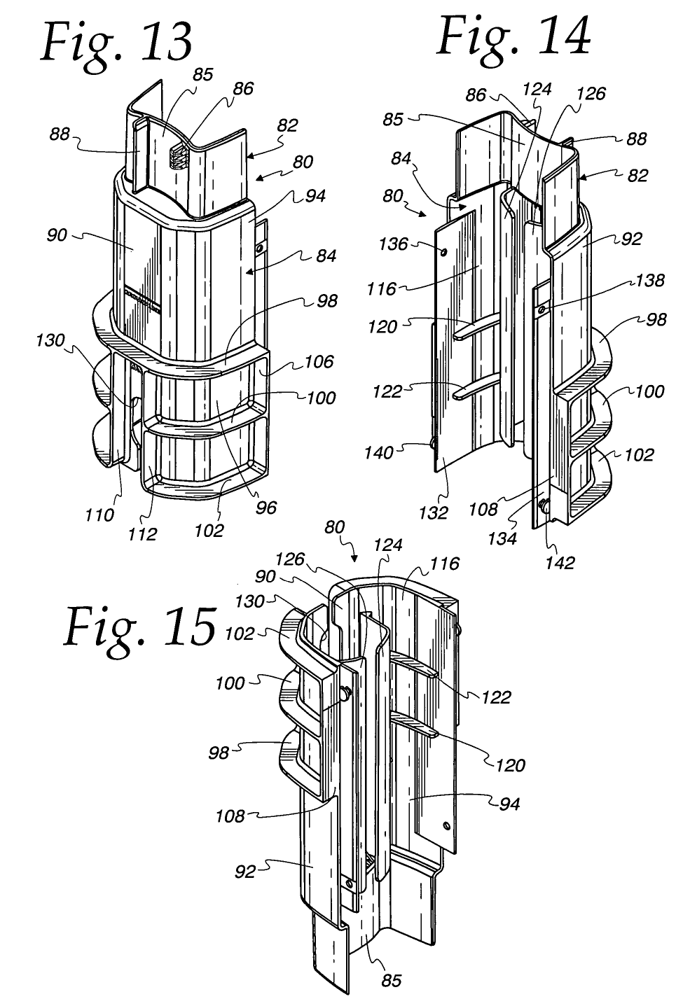

Each base 14, 20 is known as a split base and includes a front or cover section and a rear section. Referring now to FIGS. 13-15, the base cover section 80 is illustrated and is the same for both the FIG. 1 and the FIG. 2 embodiments. The cover section includes an upper portion 82 of smaller dimensions to receive the dome in a telescoping fashion and a lower portion 84 of larger dimensions, most of which portion is to be placed below ground level in use. The upper portion includes a front wall 85, a locking rib 86 in the configuration of an “E” extending from the front wall and an alignment flange 88, also extending from the front wall. The alignment flange ensures alignment of the lock body when the dome and base are being secured. The E rib provides with the lock an interference fit as will be explained below.

The lower portion 84 of the base cover section includes a front wall 90, a left side wall 92 and a right side wall 94. Integral with an outer surface 96 of the front and side walls are three horizontally disposed ribs, an upper rib 98, a middle rib 100 and a lower rib 102. The ribs extend generally in a continuous fashion around the cover section of the base. Four vertical ribs 106, 108, 110, 112 are integral with the horizontal ribs and the first vertical rib 106 extends from the right side wall, the second vertical rib 108 extends from the left side wall 92 and two vertical ribs 110, 112 extend from the front wall 90.

Integral with the inner surfaces 116, 118 of the side walls are two horizontally disposed ribs 120, 122 that are located elevationally about the same level as the outer upper rib 98 and the middle rib 100. Also molded integrally with the base cover section are two curved walls 124, 126 which form with the inner surface of the front wall an internal wire channel. The channel allows underground wires or cables to be inserted through a front opening 130 and extended within the channel upwardly in the pedestal assembly. The wall thickness of the base is a nominal 0.180 inches and the material is high density polyethylene.

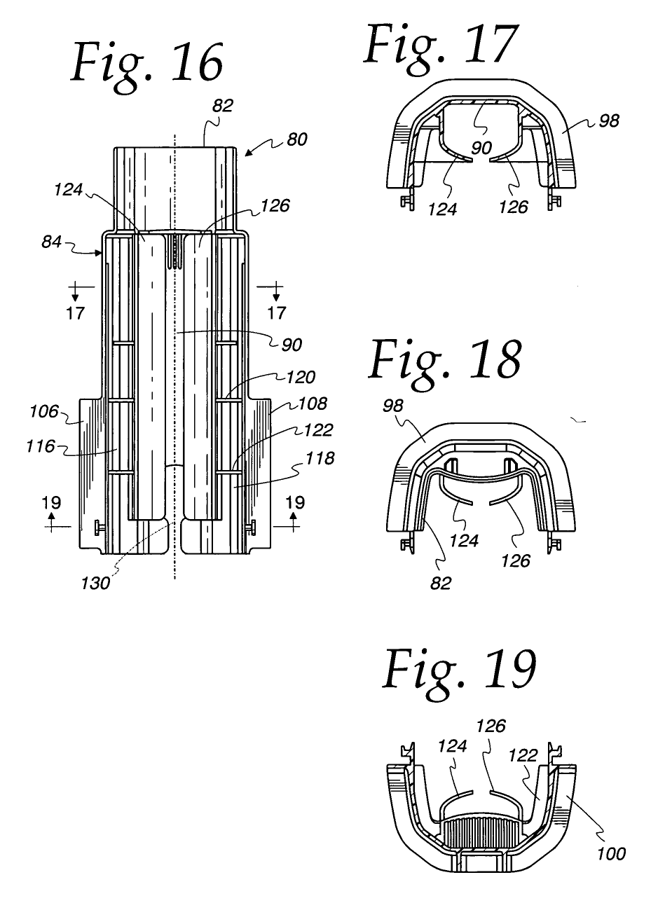

The wire channel is shown in FIGS. 16-19 as are the inner and outer horizontal ribs. The base cover section also includes vertical flanges 132, 134, FIG. 14, that extend away from the side walls so as to engage with the rear section of the base. Openings 136, 138 are provided as are fasteners 140, 142.

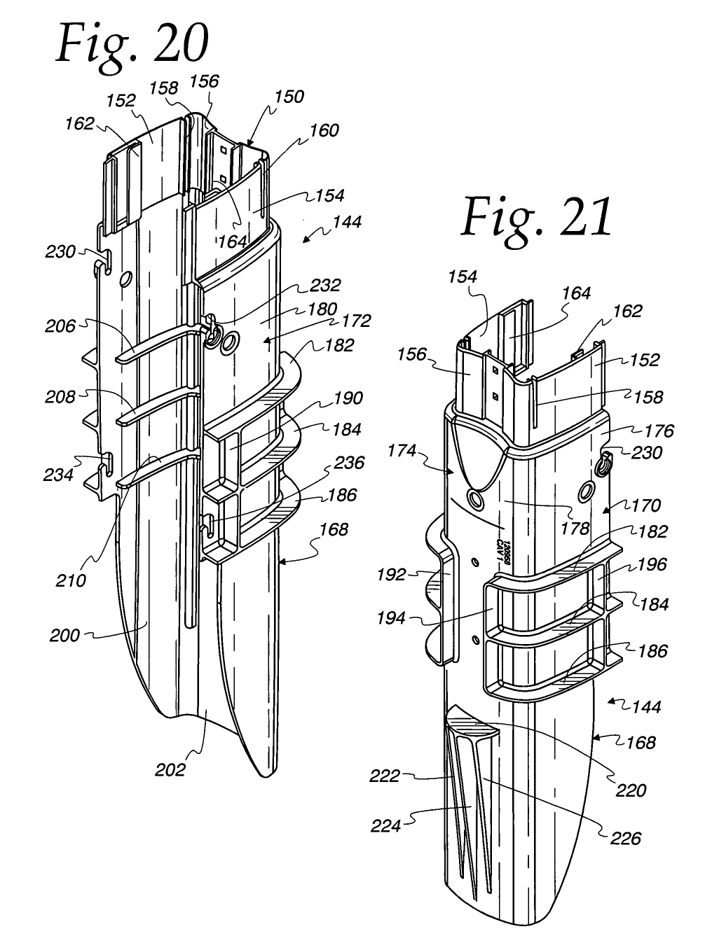

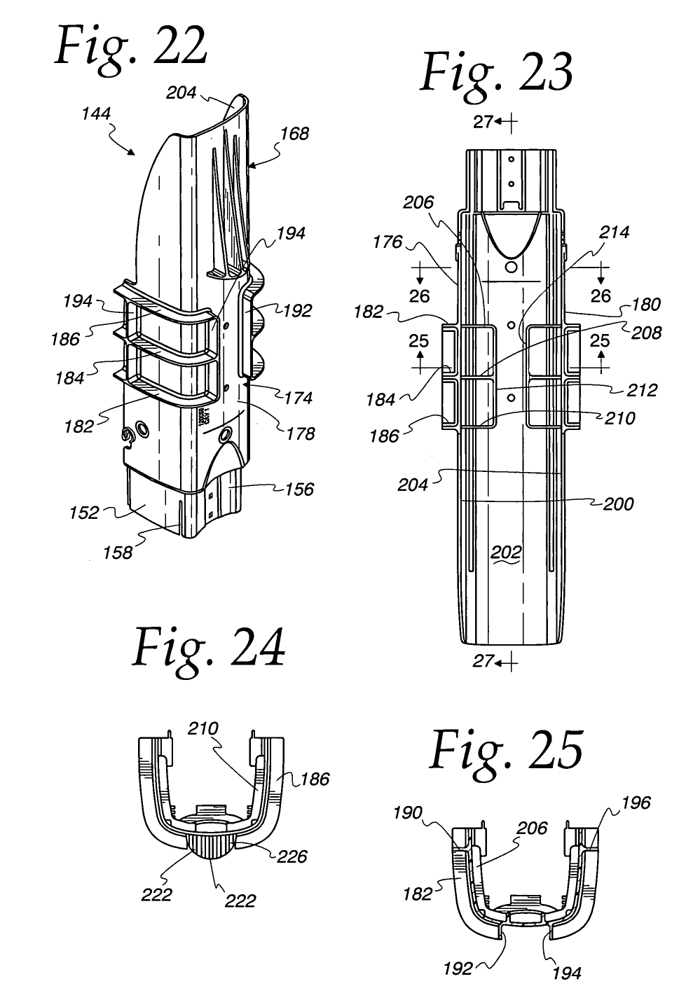

Referring now to FIGS. 20-22, the rear base section 144 of the base 20, including the spade or scoop 22 shown in FIGS. 2-5, is illustrated in greater detail. The rear base section includes an upper portion 150 having a left side wall 152, a right side wall 154 and a rear wall 156. Each side wall includes a slot 158, 160 for receiving the pair of internal, vertically extending ribs 60, 62, FIGS. 10 and 11, of the dome. The upper portion also includes a pair of channel structures 162, 164 for attaching the mounting plate 24, FIG. 2.

A lower portion 168 of the rear base section 144 includes a left wall 170, a right wall 172 and a rear wall 174. Integral with outer surfaces 176, 178, 180 of the side and rear walls are a set of three horizontally spaced ribs 182, 184, 186 and four vertically spaced ribs 190, 192, 194, 196. Integrally formed with the walls but extending from interior surfaces 200, 202, 204 are three spaced horizontal ribs 206, 208, 210 and two attached vertical ribs 212, 214, FIG. 23. As illustrated, the horizontal and vertical ribs extending from the outer surfaces of the walls of the rear base section are formed into box-like structures to enhance strength and resistance to ground extraction. The three outer horizontal ribs include the upper rib 182, the middle rib 184 and the lower rib 186. The same is true for the three interior ribs, the upper rib 206, the middle rib 208 and the lower rib 210.

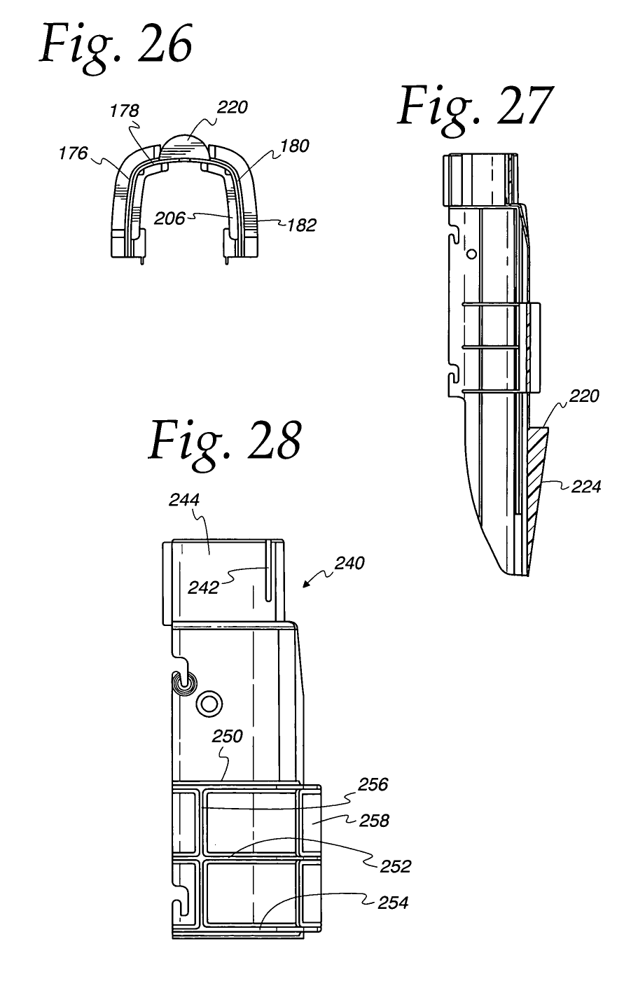

The inner and outer ribs are also shown in FIGS. 23-27 along with a horizontal step 220 and three supporting vertical flanges 222, 224, 226 extending from the rear surface 178 of the downwardly projecting spade portion of the rear base section.

The side walls 170, 172 also include two pairs of slots 230, 232 and 234, 236, FIG. 20, for receiving connectors that are used on the cover base section or added after the cover and rear base sections are brought together.

Referring now to FIG. 28, the short variation 240 of the base section is illustrated along with one slot 242 of a pair of slots in the upper portion 244 for receiving the vertical ribs 60, 62, FIG. 11, of the dome. The short version of the base also includes the same geometric pattern of outer, horizontal and vertical ribs 250, 252, 254 and 256, 258. Although not shown, the short version also includes three inner horizontal ribs and two vertical ribs, as shown and described in relation to the embodiment shown in FIGS. 20-27.

Referring now to FIGS. 29-36, there is illustrated a preferred embodiment of a lock mechanism 270. As is explained in more detail in co-pending Application No. ______, (attorney docket 560043-620640), entitled “Quarter Turn Slide Lock Assembly” and owned by the assignee of the present invention, the lock includes a base 272, a cover 274, a slider 276, a rotator 278 and two compression springs 277, 279.

The base 272 includes an outside surface having two slanted end panels 290, 292, two slanted sides 294, 296 and a grill-like top 298. The end panels are slanted at about 40-45 degrees from a horizontal reference and the sides are slanted at about 30-35 degrees from a horizontal reference and all intersections are rounded as shown. The base also includes a rear wall 300 and a slider channel formed by the rear wall, two spaced apart lateral walls 302, 304 and a base side wall 306. The base also includes two spring guides 307, 308, four snap openings 310, 312, 314, 316 and two rivet receiving openings 318, 320. A hole 322 is formed in the base wall 306 for the rotator. The base further includes a key groove 324, a pair of drain ports 326, 328 in the lateral wall 302 and another pair of drain ports 330, 332 in the bottom end 334 of the base.

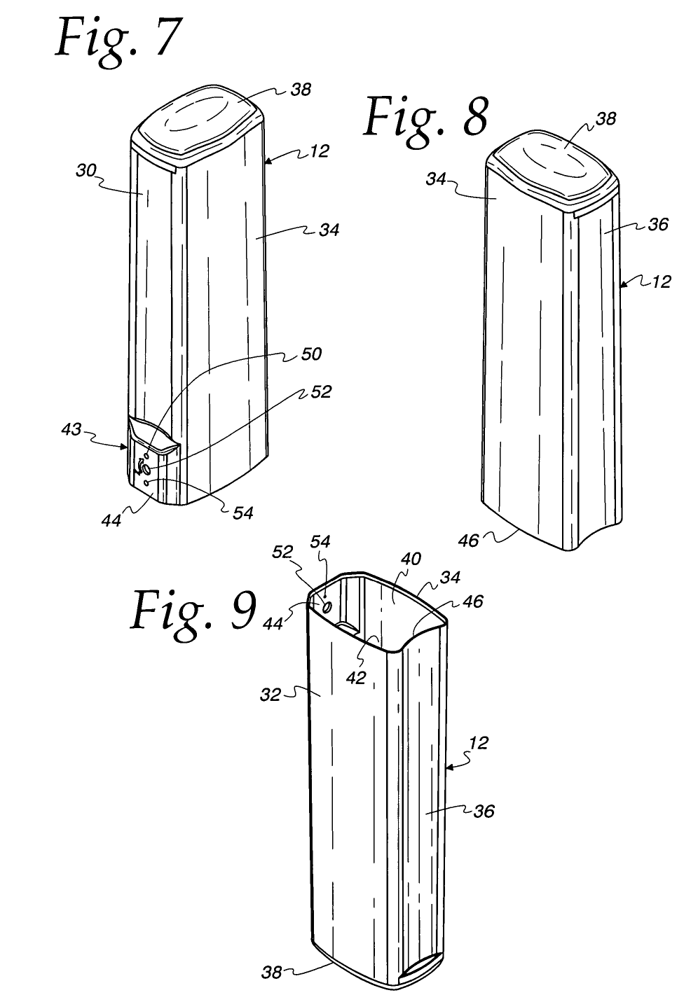

The cover includes a key groove 340 along its upper edge. The key grooves 324, 340 of the base and the cover mate with the key tab 72, FIG. 11, formed in the dome. This allows the lock to be correctly and quickly aligned in and assembled with the dome. Two aligned openings 342, 344 are formed in the cover and these align themselves with the opening 318, 320 in the lock base and the two small openings 50, 54, FIG. 7, in the dome 12. The aligned openings allow rivets to be attached to the dome and to the lock so as to fasten the lock to the dome. The cover also includes a large central opening 345, a surrounding security ring 346 to prevent tampering and four snap arms 347, 348, 349, 350.

The rotator 278 has a hex shaped head 351 as shown in FIG. 29. The hex head extends through the central opening 345 in the cover. The security ring around the head formed integral with the cover prevents a typical household tool, such as pliers, or a wrench from effectively engaging the hex head. This arrangement makes the hex head accessible only to a specially constructed opening tool. The rotator 278 also includes a cylindrical body 352 and a cam arm 354.

The slider 276 includes outer slide walls 360, 362, an end wall 364 and an outer cam follower wall 366. The slider also has a base wall 368 with a slot opening 370 to receive the rotator, an inner cam follower wall 372 and two limit tabs 374, 376. When the hex head of the rotator is rotated a quarter turn or about ninety degrees, the cam arm 354 bears against the inner cam follower wall 372 of the slider and thereby retracts the slider to the left, when viewed as in FIG. 36, from its extended position shown in FIG. 35. Moving the slider to the left compresses the two springs and creates a sufficient rightward biasing force to return the slider to its extended position when the opening tool is removed. In a similar fashion, when the dome and lock are brought together with the pedestal base, the E rib 86, FIG. 13, acts as a cam to bear against the outer cam follower wall 366 of the slider causing it to retract until the slider passes the E-rib. Once passed, the springs bias the slider to its extended position to cause an interference fit between the E-rib and the slider wall 360.

It is noted that the slanted outer surfaces 290, 292, 293, 296 of the lock mechanism which extend into the interior of the pedestal closure assembly do not snag wires situated there as the dome is moved relative to the pedestal base during dome removal or installation. This is because there are no sharp corners and because the lock mechanism is located in the bulge of the dome.

The purpose of the outer and inner ribs on the pedestal base is to provide greater stability to the pedestal closure assembly when it is installed in the ground. Customers of such pedestals prefer to excavate shallow pits in which pedestal assemblies are then installed. For example, the short or shallow pedestal embodiment shown in FIG. 1 may be situated in a hole dug to a depth of only about ten inches. The pedestal is then positioned and earth or sand or other ground medium is used to compact around the base both outside and inside. It has been found that a spacing of about three and one half inches between horizontal ribs gives good results against easy pullout from the ground. The width of each rib is approximately one inch. The spacing of the inner ribs is analogous to that of the outer ribs and the inner ribs are a little less than an inch in width.

When the spade version of the pedestal is used, ground stability is improved but the spade is not essential to the proper functioning of the pedestal. Also, openings, 380, 382, FIG. 1, are provided to attach a metal stake which may be used to enhance ground stability of a short base pedestal. Once again, however, there is no requirement that a stake be used.

The internal vertical ribs of the dome and the slots in the pedestal base provide for an inner lock along the rear of the pedestal. In combination with the lock mechanism at the front of the pedestal, a strong, secure arrangement is provided for attachment of the dome to the pedestal base.

While a strong all around attachment is made, a technician need only use a special tool with the lock mechanism and rotate the tool ninety degrees to cause the lock to disengage and allow the removal of the dome from the pedestal base. Thus, a technician need only go to a single point to allow disengagement of the dome. Furthermore, the technician need only use a single tool and a simple ninety degree twist for the unlocking step. To reassemble the dome with the pedestal base, a technician merely aligns the ribs of the dome and the slots of the base and pushes downwardly. The slider of the lock will be retracted by the camming action of the E rib and will automatically snap into a locking position once the E rib has been passed.

In operation the pedestal is installed over an underground cable and is typically buried in the ground to about ten inches not including a spike or the spade version of the pedestal. Because of the outer and inner ribs around the pedestal base, a relatively shallow hole or pit need be dug. This is a time and labor saving advantage for the pedestal of the present application. Once the pedestal is placed in the ground, soil, sand or the like is compacted around the pedestal to ensure that the pedestal remains upright. Because of the ribs, great stability in the ground is achieved.

After installation in the ground, the pedestal may be easily opened for service. To gain access to the cables, wires, connectors and the like that are housed within the pedestal, a technician need only place a tool on the hex head rotator of the slide lock and twist the hex head a quarter turn. This retracts the slider of the lock away from abutting engagement with the E rib on the pedestal base so that the dome may be raised upwardly and away from the base. After completion of service, the dome may be replaced on the pedestal base simply by aligning the vertical ribs of the dome with the slots in the base and pushing downwardly so that the E rib cams the slider of the lock to a retracted position. When the E rib has been passed by the lock, the slider automatically extends so as to create an interference abutment thereby locking the dome to the base.

The above specification describes in detail two preferred embodiments of the present invention. Other examples, embodiments, modifications and variations will, under both the literal claim language and the doctrine of equivalents, come within the scope of the invention defined by the appended claims. For example, slightly different shapes for the dome and pedestal base or the lock and E rib are still considered equivalent structures and will also come within the literal language of the claims. Still other alternatives will also be equivalent as will many new technologies. There is no desire or intention here to limit in any way the application of the doctrine of equivalents nor to limit or restrict the scope of the invention.

1. A pedestal closure assembly comprising:
a substantially monolithic upper dome; and
a base for receiving said dome, said base having separable front and rear sections, each said sections having outer and inner extending horizontal ribs.

2. The apparatus as claimed in claim 1 including:
vertical ribs extending inwardly and outwardly from said base.

3. The apparatus as claimed in claim 2 wherein:
said horizontal and vertical ribs are connected.

4. The apparatus as claimed in claim 3 wherein:
the outer extending horizontal ribs includes an upper rib, a middle rib and a lower rib.

5. The apparatus as claimed in claim 4 wherein:
the front base section includes two horizontal ribs; and
said rear base section includes three horizontal ribs.

6. The apparatus as claimed in claim 5 wherein:
the upper horizontal rib extends along side walls, a front wall and along a portion of a back wall of said front and rear base sections.

7. The apparatus as claimed in claim 6 wherein:
the middle horizontal rib extends along said side walls and a portion of said front and back walls.

8. The apparatus as claimed in claim 7 wherein:
the lower horizontal rib extends along said side walls and partially along said front and said back walls.

9. The apparatus as claimed in claim 8 including:
a pair of slots in the rear base section; and
a pair of ribs in the interior of said dome for engaging said slots.

10. The apparatus as claimed in claim 1 including:
a pair of slots in the rear base section; and
a pair of ribs in the interior of said dome for engaging said slots.

11. The apparatus as claimed in claim 9 including;
a lock mechanism in the lower portion of said dome.

12. The apparatus as claimed in claim 1 including:
a lock mechanism in the lower portion of said dome.

13. The apparatus as claimed in claim 1 including:
a depending spade with a step structure.

14. A pedestal closure assembly comprising:
a substantially monolithic upper dome;
a base for receiving said dome, said base having separable front and rear sections; and
a lock mechanism mounted to a lower portion of said dome, said lock mechanism requiring generally a quarter turn to cause said lock to be in an unlocked position.

15. The apparatus as claimed in claim 14 including:
outer and inner extending horizontal ribs connected to said base.

16. The apparatus as claimed in claim 15 including:
vertical ribs extending inwardly and outwardly from said base.

17. The apparatus as claimed in claim 16 wherein:
said horizontal and vertical ribs are connected.

18. The apparatus as claimed in claim 17 including:
a pair of slots in the rear base section; and
a pair of ribs in the interior of said dome for engaging said slots.

19. The apparatus as claimed in claim 18 including:
a lock mechanism in the lower portion of said dome.

20. A pedestal closure assembly comprising:
a substantially monolithic upper dome having an interior wall;
a base for receiving said dome, said base having separable front and rear sections;
a rib mounted vertically on said interior wall of said dome; and
a slot formed in said base for receiving said rib.

21. The apparatus as claimed in claim 20 including:
outer and inner extending horizontal ribs connected to said base.

22. The apparatus as claimed in claim 21 including:
vertical ribs extending inwardly and outwardly from said base.

23. The apparatus as claimed in claim 22 wherein:
said horizontal and vertical ribs are connected.

24. The apparatus as claimed in claim 23 including:
a lock mechanism in the lower portion of said dome.

25. The apparatus as claimed in claim 20 including:
a lock mechanism in the lower portion of said dome.

26. A pedestal closure assembly comprising:
a one piece upper dome with no openings above a lower end portion, said dome including a bulge in said lower end portion;
a base for receiving said dome; and
a lock mechanism mounted in said bulge for engaging said dome and said base.

27. The apparatus as claimed in claim 26 wherein:
said dome includes an interior vertically extending rib; and
said base includes an interior vertically extending slot for receiving said rib.

28. The apparatus as claimed in claim 27 wherein:
said lock mechanism is located in a first portion of said dome and said rib is disposed in a second portion of said dome.

29. The apparatus as claimed in claim 28 wherein:
said first portion of said dome is the front portion of said dome and said second portion of said dome is the rear portion of said dome.
